(19) United States
(12) Patent Application Publication
(10) Pub. No.: US 2009/0067842 A1
(43) Pub. Date: Mar. 12, 2009

(54) OPTICAL PULSE REGENERATION BASED ON PULSE TEMPORAL SHAPING

(75) Inventors: Keith James Blow, Woodbridge (GB); Sonia Annarita Boscolo, Birmingham (GB); Sergie Konstantinovich Turitsyn, Oldbury (GB)

Correspondence Address: DARBY & DARBY P.C., P.O. BOX 770, Church Street Station, New York, NY, 10008-0770, US

(73) Assignee: ASTON UNIVERSITY, Birmingham (GB)

(21) Appl. No.: 11/721,966

(22) PCT Filed: Dec. 15, 2005
(86) PCT No.: PCT/GB2005/004842

§ 371 Date: Oct. 18, 2007

(30) Foreign Application Priority Data
Dec. 15, 2004 (GB) 0427374.4

(51) Int. Cl. H04B 10/04; H04J 14/02

(52) U.S. Cl. 398/79; 398/182

(57) ABSTRACT

An optical pulse regeneration unit comprising means for broadening the temporal width and flattening the center portion of an optical pulse and slicing means for slicing the pulse at a point in time so that in use, the pulse immediately after the slicing means contains only the portions of the pulse which at the slicing means were within a specific temporal width/interval about the point in time.

This invention relates to an optical pulse regenerator, in particular, but not exclusively, for use in optical fibre communication systems employing return-to-zero (RZ) optical pulses. The invention also relates to an optical pulse regeneration unit within an optical fibre transmission line, and to an optical pulse regeneration unit within a RZ optical receiver.

With known optical fibre communication systems whenever an optical data signal such as one comprising RZ pulses, is generated, transmitted, or processed, the quality of the signal deteriorates. There are three main factors that contribute to the deterioration of the signal quality: firstly amplitude noise, which consists of fluctuation of the amplitude of the pulses and/or growth of noise and radiation background on the pulse zero level, secondly distortion of the pulse shape, and thirdly timing jitter, a term used to refer to fluctuation of the pulse position in time. The deterioration of the signal quality generally increases with the transmission distance and/or with the number of processes made with the optical data of pulses.

It is known to mitigate degradation of the signal by using one or more regenerators within the system. The purpose of the regenerators is to restore the quality of the signal.

t is known to provide both so called 2R regenerators, which can re-amplify and reshape the signal pulses, and 3R regenerators, which provide pulse retiming also. However these regenerators are generally opto-electronic and, it is preferable to avoid using electronics in the signal regeneration.

It is known to use the effect of the Kerr non-linearity in a normal dispersion fibre to reduce the effect of timing jitter at a RZ optical receiver.

UK Patent Application No. 04023344.6 describes an optical pulse regenerator comprising means for broadening and flattening the temporal waveform of an optical pulse, such as a section of normal dispersion fibre, along with a saturable absorber and an optical amplifier. The pulse broadening and flattening in this instance permits to improve the phase margin of RZ optical data signals and this, in turn, reduces the effect of timing jitter. The saturable absorber provides 2R regeneration of the optical signals.

According to a first aspect of the invention, there is provided an optical pulse regeneration unit comprising means for simultaneously broadening the temporal width and flattening the center portion of an optical pulse and slicing means for slicing the pulse at a point in time so that in use, the pulse immediately after the slicing means contains only the portions of the pulse which at the slicing means were within a specific temporal width/interval about the point in time. Preferably the means for slicing the pulse is operable to adjust the degree of narrowness and/or sharpness of the waveform of the temporally sliced pulse by altering a transfer function applied thereby to the optical pulse.

Most preferably, the broadening of the temporal width of an optical pulse, according to the present invention, is a broadening of the duration of the pulse, or a lengthening of the pulse. For example, such a broadening may result in the intensity in the broadened pulse remaining above a zero level for a longer time as a result of broadening. The term temporal width preferably refers to temporal duration or length.

According to a further aspect of the invention, there is provided an optical pulse regeneration unit for incorporation into a return-to-zero optical receiver. The optical pulse regeneration unit comprises the means for pulse temporal broadening and flattening and subsequent temporal slicing provided in the first aspect of the invention.

The means for slicing the pulse is preferably operable to alter the transfer function applied thereby to the optical pulse without altering the modulation depth thereof. Preferably, the means for slicing the pulse is operable to alter the transfer function applied thereby to the optical pulse without altering the bit period thereof. The transfer function may be non-linear.

The means for broadening the temporal width and flattening the centre portion of an optical pulse is most preferably arranged to achieve said broadening of said temporal width by increasing the duration of the optical pulse.

Preferably the means for broadening the temporal width and flattening the center portion of an optical pulse comprises a section of optical fiber having a negative group delay dispersion coefficient, that is a section of normal dispersion fiber.

Preferably the means for slicing slices a plurality of pulses and is adapted to act repeatedly at points in time separated by a predetermined time interval.

Preferably the means for slicing is adapted to have a specific transfer function so that in use the pulse immediately after the slicing means contains only the portions of the pulse before the slicing means that were within a specific temporal profile about the point in time defined by the peak of the transfer function.

Preferably the portions of the pulse within the specific temporal width about the point in time comprise only parts or all of the flattened center portion.

Preferably the transfer function of the slicing means is modified so that the narrowness and/or sharpness is varied, and preferably increased, but the modulation depth and bit period is unaltered, and/or is adapted so that the transfer function is alterable so that the narrowness and/or sharpness can be varied, preferably without effecting the modulation depth or bit period. Preferably the transfer function is non-linear.

Preferably the length of the fiber is selected so that the flattened pulse portion is broad enough that the portions of the pulse within the specific temporal width/interval have substantially constant amplitude.

It will be understood that the above apparatus and means described above may implement a signal regeneration method encompassed by the present invention.

According to a further aspect of the invention there is provided a method of regenerating a signal of optical pulses comprising the steps of, broadening the temporal widths and flattening the center portions of the pulses and, temporally slicing the broadened and flattened pulses to remove portions of pulses in the signal and preferably the removed portions are the non-central portions of pulses in the signal. Preferably, the method includes adjusting the degree of narrowness and/or sharpness of the waveform of a temporally sliced pulse by altering a transfer function applied thereto when slicing.

The method may include altering the transfer function applied thereby to the optical pulse without altering the modulation depth thereof. The method may include altering the transfer function applied thereby to the optical pulse without altering the bit period thereof. The transfer function may be non-linear. The broadening of said temporal width is most preferably by increasing the duration of the optical pulse.

Preferably the steps of broadening and flattening comprise transmitting the signal through a section of fiber with negative dispersion coefficient to broaden the temporal widths and flatten the center portions of the pulses through dispersion and Kerr non-linearity.

Preferably the slicing is done by transmitting the signal of amplified broadened and flattened pulses through an optical device which acts as an optical gate/applies a transfer function to pulses in the signal.

The method may be used for application to single-channel optical pulse signals or wavelength-division multiplexed pulse signals and may preferably be applied to wavelength-division multiplexed signals after signal de-multiplexing.

Preferably the step of adjusting the power of the optical pulses being transmitted through the fiber and/or the fiber effective length to vary the amount of non-linearity in the fiber in order to crate the desired amount of broadening and flattening for the pulses and/or there is provided the step of adjusting the degree of narrowness and/or sharpness of the temporally sliced pulse waveforms by applying different transfer functions, preferably including a non-linear transfer function, when slicing the signal pulses.

Preferably, the means for simultaneous broadening and flattening of the temporal waveforms of optical pulses comprises a section of optical fibre having a negative dispersion coefficient, that is, a section of normal dispersion fibre. Beneficially, the effective amount of non-linearity in the normal dispersion fibre means for pulse broadening and flattening can be measured in terms of the power of the optical pulses being transmitted through the fibre and the fibre effective length, which accounts for the attenuation properties of the fibre. More preferably, the normal dispersion fibre means for pulse broadening and flattening is enhanced by the use of an optical amplifier, which amplifies the power of the optical pulses being transmitted through the fibre. The optical amplifier is preferably a lumped erbium-doped fibre amplifier placed in front of the normal dispersion fibre. The optical amplifier may alternatively be a distributed Raman amplifier. In this case, the normal dispersion fibre means for pulse broadening and flattening is desirably used as the amplifying medium.

Beneficially, the normal dispersion fibre means for pulse broadening and flattening can be used to transfer return-to-zero optical pulses to non-return-to-zero-like pulses. Preferably, the no-return-to-zero-like pulses have a rectangular-like temporal profile. They may alternatively have a parabolic temporal profile.

Preferably, the means for slicing the temporal waveforms of optical pulses comprises a synchronous amplitude modulator. The synchronous amplitude modulator may be a standard amplitude modulator or a modified amplitude modulator having a specially designed transfer function. The means for slicing the pulse temporal profiles may alternatively be any optical device that acts as an optical temporal gate. The temporal gating optical device may have a linear or nonlinear transfer function.

Beneficially, a regeneration method is provided within all-optical 3R regeneration ia optical communication, which provides suppression of the timing jitter of a signal of optical pulses. The timing jitter suppression preferably occurs through broadening of the temporal widths and simultaneous flattening of the center portions of the optical pulses comprised within the signal, such as produced by group-velocity dispersion and Kerr non-linearity in a normal dispersion fibre, and subsequent slicing of the center portions of the pulse temporal profiles by a temporal gating optical device, such as a synchronous amplitude modulator.

Beneficially, such a regeneration method might be applied to single-channel optical pulse signals, or wavelength-division multiplexed signals. In this case, the regeneration method is preferably applied after signal de-multiplexing.

Preferably, an optical pulse regeneration unit is provided for use as an in-line element within an optical fibre transmission line, which comprises a housing containing components for embodiment of a regeneration unit according to the invention in any of the preceding paragraphs.

Preferably, an optical pulse regeneration unit is provided with a return-to-zero optical receiver, which comprises components for embodiment of the regeneration unit according to the invention. Beneficially, such a regeneration unit can be employed in front of the detector.

Embodiments of the specific invention will now be described in detail, by way of example only, with reference to the accompanying drawing in which:

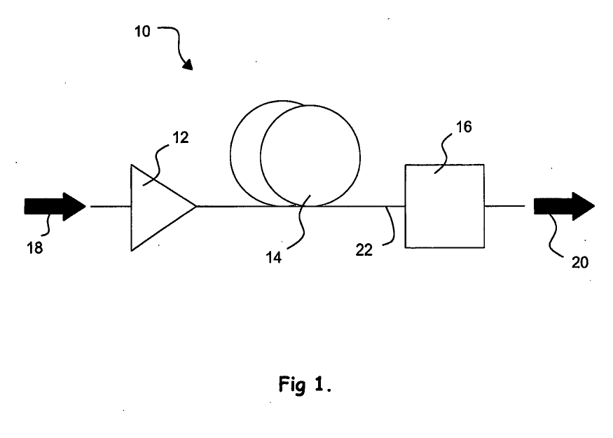

FIG. 1 is a schematic representation of an optical pulse regeneration unit in accordance with the invention;

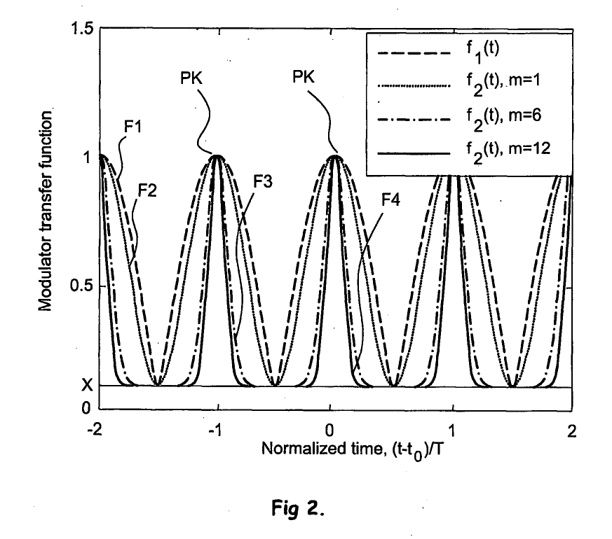

FIG. 2 is a graph showing the transfer functions of a standard amplitude modulator and a modified amplitude modulator suitable for use in the regeneration unit of FIG. 1;

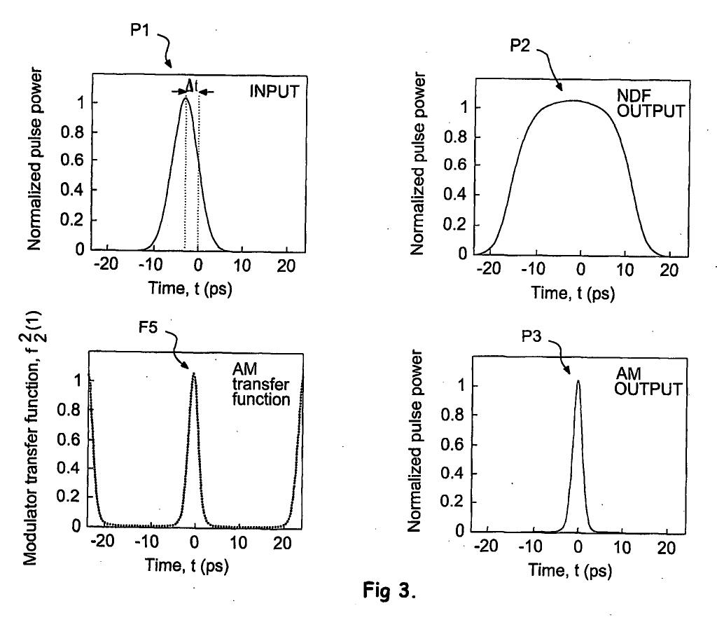

FIG. 3 is a schematic illustrative view of pulse temporal profiles at discreet stages of transmission through the regeneration unit of FIG. 1;

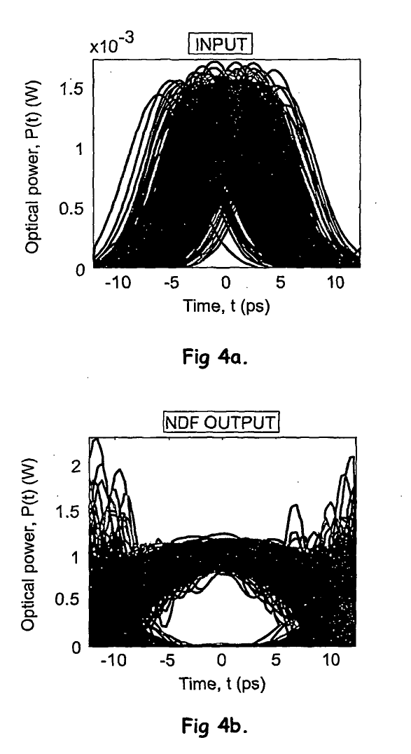

FIGS. 4a to 4d show a graph illustrating the optical eye-diagrams of a data signal within various stages in the regeneration unit of FIG. 1;

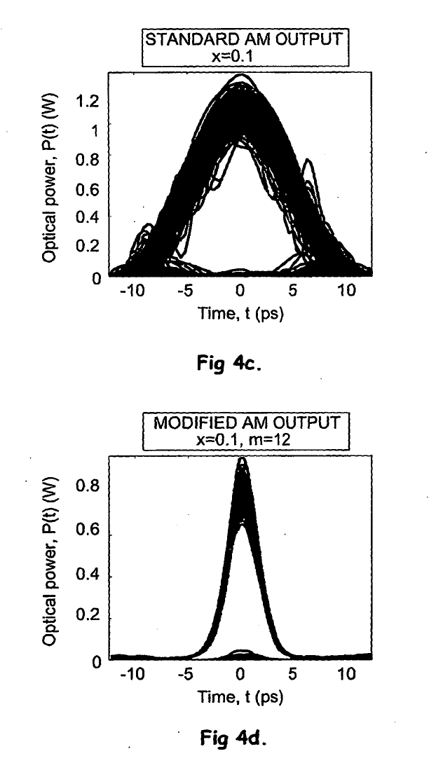

FIG. 5 is a plot of the signal timing jitter reduction factor as a function of the modulation depth parameter, in embodiments of the regeneration unit of FIG. 1;

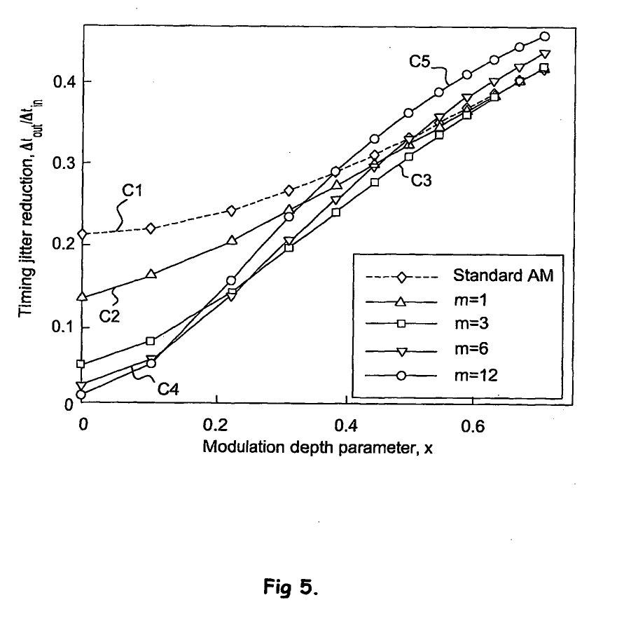

FIG. 6 is a plot of the signal timing jitter reduction factor as a function of the effective non-linearity parameter of the normal dispersion fibre, in embodiments of the regeneration unit of FIG. 1.

Referring to FIG. 1, there is shown an optical pulse regenerator/optical pulse regeneration unit 10 comprising an optical amplifier 12, a section of normal dispersion fibre (NDF) 14, and a synchronous amplitude modulator (AM 16. All three components are located in between an input 18 located nearest the amplifier 12 and an output 20 located downstream of the AM 16. Point 22 constitutes both the output from the NDF 14 and the input for the amplitude modulator 16. The amplifier 12 is in this example a lumped erbium-doped fibre amplifier (EDFA).

Referring to the regeneration unit 10, the EDFA 12 has a noise figure of 4.5 dB.

The NDF 14 in this example is 0.5 km long, and has a dispersion coefficient of −20 ps/(nm km), a nonlinear coefficient of 4.28 (W km)₋₁, and an attenuation of 0.24 dB/km. NDF 14 used as the means for pulse broadening and flattening may alternatively be any optical fiber having a negative dispersion coefficient, with any values for the magnitude of dispersion, non-linearity, and attenuation parameters.

Referring to the regeneration unit 10, the synchronous AM 16 is preferably of a modified form. It is possible to use a conventional AM 16 having an amplitude transfer function that may be written as

$${f}_{1} ( t ) = {\{ \frac{1}{2} [ 1 + {x}^{2} + ( 1 - {x}^{2} ) cos ( \frac{2 π ( t - {t}_{0} )}{T} ) ] \}}^{1 / 2} ,$$

where, 1−x defines the modulation depth, t₀ is the center of the modulation, and T is the bit period.

Alternatively it is possible to use a modified form of AM 16. The modified form of the AM 16 can be modified to have a nonlinear transfer function given by

$${f}_{2} ( t ) = x + ( 1 - x ) {cos}^{2 m} ( \frac{π ( t - {t}_{0} )}{T} ) , m = 1 , 2 , K$$

where parameter m controls the degree of slicing of the pulse temporal profile. Function ƒ₂(t) is designed to have the same period T and the same modulation depth. 1−x as function ƒ₁(t). Control over parameter m permits to enhance the optical gating effect of the AM.

Instead of an amplitude modulator any suitable optical device acting as a temporal gate, such as a nonlinear optical loop mirror provided with a clock, may be used instead. Such a gate would likely provide a different nonlinear transfer function to those defined above but would preferably have the sane important properties as the modified AM has in function f₂ in that it would open a narrow window in time with periodicity T.

In FIG. 2 is shown the amplitude transfer function for alternative embodiments of the AM 16. Four functions F1, F2, F3, and F4 are illustrated, where Fl represents the conventional AM with function ƒ₁(t), and F2, F3, and F4 represent the modified AM with function f₂(t) and with parameter m equal to 1, 6, and 12, respectively.

As shown in FIG. 2, the modified AM 16 exhibits narrower and sharper modulation peaks PK than the conventional AM 16, and narrowing and sharpening of the peaks of the modulation PK increases with increasing values of m.

In FIG. 2 with the value of f(t) against normalized time t-t_{0/}/T the peaks PK₁, P2₂ are located in the same position for all of the functions F1, F2, F3 and F4 and with the same height due to the nature of the transfer functions explained above. In each case the function F1 to F4 travels through zero halfway between the peaks i.e. normalized time 0.5, 1.5 etc.

As shown in FIG. 2 modified amplitude modulator 16 produces narrower and sharper peaks PK. Comparing F1 and F2 it is seen that the peaks f₂ are sharper and narrower and as the value of m is increased for F3 and F4 the peaks become sharper and narrower still so that in the case of F4 much of the plot of the transfer function is close to zero in between peaks.

In-use optical pulses are transmitted in the regeneration unit 10 from the input 18 through the NDF 14, then through the AM 16, and to the output 20. A pulse incoming to the regeneration unit is firstly amplified by the optical amplifier 12 in order to enhance the effect of non-linearity in the NDF 14 the pulses are then sent through AM 16 and onto output 20. For given magnitudes of dispersion and non-linearity parameters, the effective amount of non-linearity in the NDP 14 may be varied by varying the power of the optical pulses being transmitted through the fiber and/or the fiber effective length.

During transmission through the regeneration unit 10, the pulses are altered in temporal profile. In FIG. 3 is shown an illustrative schematic view of the pulse temporal intensity profiles P1, P2, and P3 at the input 18, the NDF output 22, and the output 20, respectively. Also illustrated is the intensity transfer function F5 of the modified AM 16 used to produce the changes in profiles form P1 to P3.

Referring to FIG. 3, the intensity peak of the pulse P1 at the input 18 is shifted in time by an amount □t with respect to the center of the timing slot to. In this example, the pulse P1 is undistorted and, therefore, the time position of the intensity peak coincides with the time position of the center of mass.

During transmission along the NDF 14, the temporal waveform of the optical pulse P1 changes to a rectangular-like profile P2 by the combined action of group-velocity dispersion and Kerr non-linearity. After propagation in the NDF 14, the pulse temporal width is broadened and the center portion of the pulse changes to be flat. By utilizing this property, the phase margin of a return-to-zero (RZ) pulse train can be improved and, consequently, the influence of the displacement of the pulse position in time caused by timing jitter can be reduced. Indeed, broadening of the pulse width to approximately a bit duration causes the center of mass of the pulse portion contained in the bit timing slot to move towards the pulse top, where timing jitter is less than in the tails as a result of the flattening of the pulse envelope.

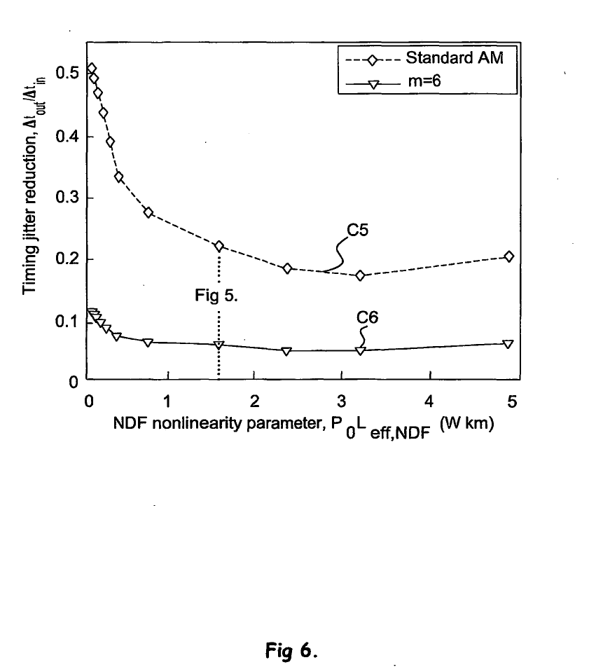

Following the NDF 14, the pulse transmits through point 22 and enters the AM 16. The AM 16 retimes the pulse (that is, brings At to substantially zero) and acts as an optical gate in slicing the center portion of the broadened pulse temporal profile P2 within the transfer function F5. Consequently, the pulse profile is changed from profile P2 to resembling profile P3. The pulse width and the shape of pulse P3 at the output 20 are mainly determined by the width and shape of the modulation peaks of the AM transfer function. Because the modulation peaks are narrower than the incoming pulse P2 to the AM 16, only the center portion of pulse P2 is sliced, and the pulse tails are discriminated against. This effective discrimination of the pulse tails against the center portion enables efficient suppression of the timing jitter of a pulse train. FIGS. 4-6 illustrate the performance of the regeneration unit 10. To create the diagrams of FIGS. 4-6, 40 Gbit/s pseudorandom RZ single-channel pulse trains of bit length N=1024 are used as a typical illustrative input for the regeneration unit 10, after transmission in a system whose transmission performance is severely limited by timing jitter. The input full-width at half-maximum (FWHM) pulse width is approximately 7 ps.

Referring to FIGS. 4-6, the timing jitter □t of a pulse train is calculated as

$$Δ t = {[ \frac{1}{N} {\sum }_{i = 1}^{N} {( {T}_{i} - \overline{t} )}^{2} ]}^{1 / 2} , {T}_{i} = {t}_{i} \frac{{\overline{P}}_{i}}{{\overline{P}}_{toi}} , {t}_{i} = \frac{{\int }_{- T / 2}^{T / 2} d {ttP}_{i} ( t )}{{\int }_{- T / 2}^{T / 2} d {tP}_{i} ( t )} , \overline{t} = \frac{1}{N} {\sum }_{i = 1}^{N} {T}_{i} ,$$

where, P̅ᵢ is the average optical power of the i-th bit in the pattern, P̅ₜₒₜ is the average optical power of the bit pattern, tᵢ is the time position of the center of mass of the i-th bit, and Pᵢ(t) is the instantaneous power of the i-th bit. To account for more statistical realizations, □t is averaged over four pseudorandom pulse trains. The calculations are made for the optical field filtered by a Gaussian optical filter to limit the bandwidth of the amplified spontaneous emission noise. Transfer functions for both a conventional and modified AM 16, with are used T25 ps (corresponding to 40 Gbit/s data rate). The modulation peak t₀ is set to the time position t̅ of the average center of mass of the incoming bit pattern. In the examples of FIGS. 4-6, t̅ is approximately 0 ps. FIGS. 4a to 4d show examples of optical eye-diagrams. The eye-diagrams are taken at the regeneration unit input 18 in FIG. 4a, at the NDF output 22 in FIG. 4b, and at the regeneration unit output 20 in FIGS. 4c and 4d.

FIG. 4c depicts the eye-diagram when a conventional AM 16 with function F1 is used within the regeneration unit 10, whereas FIG. 4d depicts the eye-diagram when the regeneration unit 10 includes a modified AM 16 with function ƒf₂(t) give above. In these examples, the modulation depth parameter x is set to 0.1, m=12 in transfer function ƒ₂(t), and the power gain of the optical amplifier 12 is 34.2 dB. The eye-diagrams are generated from a single pulse train. Such diagrams are formed by superposing pulses corresponding to different timing slots in the pulse train on top of each other.

It can be seen in FIG. 4a that the “eye” at the regeneration unit input 18 is “closed”, that is, the eye opening (the area in the center of the diagram) is small. This is mainly due to the significant timing jitter of the optical pulses. Indeed, the positions of the centers of mass of the pulses can be seen to shift considerably from the center of the bit period The evaluated timing jitter is Δtᵢₙ₌5.9 ps.

It can be seen in FIG. 4b that the pulse duration at the NDF output 22 has been broadened. In this example, the FWHM pulse width has been broadened to approximately 26 ps. Simultaneously, the pulse shape has been flattened. Consequently, the eye opening has become appreciably wider after propagation in the NDF 14. It can also be seen that the amplitude jitter of pulses at the center of the bit period is smaller than at the input 18, while there is a slight increase of amplitude noise on the zero level of the pulses. The evaluated timing jitter at the NDF output 22 is Δt_{NDF}=3.1 ps. This effective reduction of timing jitter at the NDF output is due to the displacement of the centers of mass of the portions of broadened pulses contained in the bit timing slots towards the pulse flat tops. Referring to FIGS. 4c and 4d, the eye-diagrams at the regeneration unit output 20 show that the time shifts of pulses are efficiently restored by both types of AM 16. It can be seen that the ability of timing restoration of the modified AM 16 is improved. Indeed, in this example, the estimated output timing jitter is Δtₒᵤₜ=1.3 ps when the standard AM 16 is used, and Δtₒᵤₜ=0.31 ps when the modified AM 16 is used. It is also seen that, when the standard AM is used, the pulse shape at the regeneration unit output 20 is not substantially changed as compared with that at the regeneration unit input 18, and the FWHM pulse width is approximately 12 ps. On the other hand, when the modified AM is used, the regenerated pulses at the output 20 have sharper edges and a narrower width. The FWHM pulse width in this example is approximately 3 ps. The slicing and reshaping of the NDF-broadened pulse waveforms by the modified AM 16 are responsible for the excellent retiming function of this type of AM.

FIG. 5 shows the ratio of the signal timing jitter at the regeneration unit output 20 to the timing jitter at the regeneration, unit input 18, Δtₒᵤₜ/Δtᵢₙ, as a function of the modulation depth parameter x for some values of parameter m of the modified AM 16.

In FIG. 5 curves C2, C3, C4, and C5 correspond to the modified AM 16 with the parameter m equal to one, three, six, and twelve, respectively. The timing jitter reduction factor for the standard AM 16 is also shown by curve C1. The amplifier gain is in this example 34.2 dB. It can be seen that for both AM 16 types, the strength of time restoration decreases with increasing x (decreasing modulation depth). It can also be seen that for small values of x, the retiming capability of the modified AM 16 is significantly stronger than that of the standard AM 16, and the strength of time restoration increases with increasing values of m. Timing jitter reductions down to 2% are possible with the modified AM. For high values of x, medium values of m perform better, and the retiming capabilities of the two types of AM 16 are seen to be comparable.

An effective measure of the non-linearity in the NDF 14 in the regeneration unit 10 may be given by the quantity

$${P}_{0} {L}_{eff , NDF} = {P}_{0} \frac{1 - exp ( - 2 Γ {L}_{NDF} )}{2 Γ} ,$$

where, P₀ is the pulse peak power at the NDF input after the amplifier 12, L_{eƒƒ,NDF} is the effective length of the NDF 14, L_{LDF} is the length of fibre 14, and r=0.051 n(10)α is the loss coefficient of fibre 14, with a the attenuation in dB/km.

FIG. 6 shows the timing jitter reduction factor Δtₒᵤₜ /Δtᵢₙ as a function of the NDF 14 effective non-linearity parameter defined above when both the modified AM 16 with m equal to six and the standard AM 16 are used. Curve C6 corresponds to the modified AM, whereas curve C5 corresponds to the standard AM. In this example, P₀L_{eƒƒ,NDF} is varied by varying the gain of the optical amplifier 12, and P₀ is calculated as the average peak power of the pulses contained in four pseudorandom pattern realizations. The modulation depth parameter is in this example x=0.1. For values of P₀L_{eƒƒ,NDF} less than the optimum one, less pulse broadening and flattening is achieved in the NDF 14. For values of P₀L_{eƒƒ,NDF} larger than the optimum one, the pulse width after propagation in the NDF 14 is broadened appreciably beyond the bit time slot. Both factors reduce the retiming capability of the AM, as seen from the increase of Δtₒᵤₜ/Δtᵢₙ in FIG. 6.

The optical pulse regeneration method according to the invention, which has been particularly described through its embodiment 10, therefore provides a technique within all-optical 3R regeneration in optical communication that suppresses the timing jitter of the optical pulse signals by slicing of broadened and flattened pulse temporal waveforms.

Although, the technique of the invention has been particularly described in the applications of a regeneration unit within a fibre transmission line and a regeneration unit within a RZ optical receiver the invention may be used in any application that requires pulse timing jitter suppression. Furthermore, the regeneration technique of the invention may be used in a combination with a saturable absorber, such as a nonlinear optical loop mirror, to achieve full 3R regeneration of the optical pulse signals.

Although the operation of the regeneration unit with single-channel optical data signals is particularly described, the regeneration unit may be used in optical communication systems employing wavelength-division multiplexed data signals by applying the regeneration unit after signal de-multiplexing.

While the invention has been described with a reference to an exemplary preferred embodiment, the invention may be embodied in other specific forms.

1. An optical pulse regeneration unit comprising;
a pulse reshaper for broadening a temporal width and flattening a center portion of a pulse; and
a temporal gate coupled to the pulse reshaper, the temporal gate for slicing the pulse at a point in time so that in use, a sliced pulse immediately after the temporal gate comprises portions of the pulse which at the temporal gate were within a specific temporal interval about the point in time, wherein the temporal gate is operable to adjust at least one of the following; a degree of narrowness and a sharpness of a waveform of the sliced pulse by altering a transfer function applied thereby.

2. An optical pulse regeneration unit according to claim 1 in which the temporal gate is operable to alter the transfer function applied thereby to the pulse without altering a modulation depth thereof.

3. An optical pulse regeneration unit according to claim 1 in which the temporal gate is operable to alter the transfer function applied thereby to the pulse without altering a bit period thereof.

4. An optical pulse regeneration unit according to claim 1 in which the transfer function is non-linear.

5. An optical pulse regeneration unit according to claim 1 in which the pulse reshaper is arranged to achieve said broadening of said temporal width by increasing a duration of the optical pulse.

6. An optical pulse regeneration unit according to claim 1 where the pulse reshaper comprises a section of optical fiber having a negative group delay dispersion coefficient, that is a section of normal dispersion fiber.

7. An optical pulse regeneration unit according to claim 6 further comprising an optical amplifier preferably coupled to the normal dispersion fiber, the unit being adapted so that the amplifier amplifies the pulse being transmitted through the fiber and increases a non-linearity effect in the fiber.

8. An optical pulse regeneration unit according to claim 1 wherein the temporal gate slices a plurality of pulses and is adapted to act repeatedly at points in time separated by a predetermined time interval.

9. An optical pulse regeneration unit according to claim 1 wherein the temporal gate is adapted to have a specific transfer function so that in use the pulse immediately after the temporal gate comprises portions of the pulse before the temporal gate that were, within a specific temporal profile about a point in time defined by a peak of the transfer function.

10. An optical pulse regeneration unit according to claim 1 wherein the temporal gate is an optical gate.

11. An optical pulse regeneration unit according to claim 10 wherein the optical gate comprises an amplitude modulator.

12. An optical pulse regeneration unit according to claim 10 wherein the optical gate comprises a non-linear loop mirror and clock.

13. An optical pulse regeneration unit according to claim 1 wherein the portions of the pulse within the specific temporal interval about the point in time comprise one of the following: only parts of the flattened center portion or all of the flattened center portion.

14. An optical pulse regeneration unit according to claim 10 wherein the transfer function of the optical gate is modified so that at least one of the following; the narrowness and sharpness is varied, but a modulation depth and bit period is unaltered.

15. An optical pulse regeneration unit according to claim 10 wherein the optical gate is adapted so that the transfer function is alterable so that at least one of the following; the narrowness can be varied and the sharpness can be varied, without effecting at least one of the following; a modulation depth and a bit period.

16. An optical pulse regeneration unit claim 15 wherein the modified optical gate has a non-linear transfer function.

17. An optical pulse regeneration unit according to claim 1 wherein the transfer function of the temporal gate has narrow peaks in time separated by a time interval equal to a bit period.

18. A regeneration unit according to on claim 7 wherein the optical amplifier is a lumped erbium-doped fiber amplifier or a distributed Raman fiber amplifier.

19. A regeneration unit according to claim 18, wherein the normal dispersion fiber is used as an amplifying medium for a Raman amplification process.

20. An optical pulse regenerating component within an optical return-to-zero receiver having the features of the regeneration unit of claim 1.

21. An optical pulse regeneration unit according to claim 1, wherein the optical pulse regeneration unit is within an optical return-to-zero receiver.

22. An optical pulse regeneration unit according to claim 21, wherein the optical pulse regeneration unit performs signal quality regeneration before detection.

23. An optical pulse regenerating unit comprising a housing enclosing components of a regeneration unit according to claim 1.

24. A regeneration unit according to claim 1, wherein the unit is in a transmission line and wherein the unit is adapted so that points in time at which the temporal gate acts correspond to original center points of input pulses, the unit retiming the input pulses back to their original center points after timing jitter has occurred through the line.

25. The regeneration unit according to claim 24 wherein a length of fiber of the transmission line is selected so that the flattened pulse portion is broad enough that the portions of the pulse within the specific temporal width interval have substantially constant amplitude.

26. A method of regenerating a signal of optical pulses comprising the steps of:
broadening temporal widths and flattening center portions of the pulses;
temporally slicing the broadened and flattened pulses to remove slice portions of the pulses in the signal; nd
adjusting a degree of narrowness or a sharpness of a waveform of a temporally sliced pulse by altering a transfer function applied thereto when slicing.

27. A method of regenerating a signal of optical pulses according to claim 26 including altering the transfer function applied thereby to an optical pulse without altering the modulation depth thereof.

28. A method of regenerating a signal of optical pulses according to claim 26 including altering the transfer function applied thereby to an optical pulse without altering a bit period thereof.

29. A method of regenerating a signal of optical pulses according to claim 26 in which the transfer function is non-linear.

30. A method of regenerating a signal of optical pulses according to claim 26 in which said broadening of said temporal width is by increasing the duration of the optical pulse.

31. A method of regenerating a signal of optical pulses according to claim 26 wherein the removed portions are the non-central portions of pulses in the signal.

32. A method of regenerating a signal of optical pulses according to claim 26 wherein the steps of broadening and flattening comprise transmitting the signal through a section of fiber with negative dispersion coefficient to broaden the temporal widths and flatten the center portions of the pulses through dispersion and Kerr non-linearity.

33. A method of regenerating a signal of optical pulses according claim 26 comprising the step of amplifying the pulse power before pulses are sliced.

34. A method of regenerating a signal of optical pulses according to claim 26 wherein the slicing is done by transmitting the broadened and flattened pulses through an optical device which acts as an optical gate by applying a transfer function to pulses in the signal.

35. A method of regenerating a signal of optical pulses according to claim 34 wherein the optical device is a synchronous amplitude modulator.

36. A method of regenerating a signal of optical pulses according to claim 34 wherein the transfer function is non-linear.

37. A regeneration method according to claim 32 wherein the pulses produced by the normal dispersion fiber have rectangular-like temporal profiles or parabolic temporal profiles and are non-return-to-zero-like pulses.

38. A regeneration method according to claim 26, wherein the signal comprises for application to single-channel optical pulses or wavelength-division multiplexed pulses.

39. A regeneration method according to claim 38 wherein the signal of wavelength-division multiplexed pulses is signal de-multiplexed prior to broadening.

40. A regeneration method according to claim 26, comprising of varying an amount of non-linearity to create a desired amount of broadening and flattening for the pulses by performing at least one of the following:
adjusting power of the optical pulse;
adjusting fiber effective length.

41. A method of regenerating a signal of pulses according to claim 26, wherein the step of adjusting the degree of narrowness or sharpness comprises applying different transfer functions when slicing the signal pulses.

42. A 3R regeneration method of optical pulses comprising the steps of 26.

43. An optical pulse regeneration unit according to claim 14 wherein the optical gate is adapted so that the transfer function is alterable so that the narrowness and sharpness can be varied without affecting the modulation depth or bit period.

44. An optical pulse regeneration unit according to claim 43 wherein the modified optical gate has a non-linear transfer function.
